(19) United States
(12) Patent Application Publication
(10) Pub. No.: US 2007/0091834 A1
(43) Pub. Date: Apr. 26, 2007

(54) Method of increasing the wireless communication range using wireless repeater/amplifier/router

(76) Inventor: Hyun Lee, Ladera Ranch, CA (US)

Correspondence Address: Hyun Lee, 21 Thalia St, Ladera Ranch, CA, 92694, US

(21) Appl. No.: 11/585,589

(22) Filed: Oct. 24, 2006

Related U.S. Application Data
(63) Continuation of application No. 60/730,150, filed on Oct. 25, 2005.

(51) Int. Cl. H04B 7/00

(52) U.S. Cl. 370/310; 455/11.1

(57) ABSTRACT

Description of repeater/amplifier/router for a wireless Home Media Network to work with exiting and upcoming new wireless personal and home network protocol. This invention can be implemented in various ways, such as with firmware, with software, with hardware, or with any combinations of firmware, software, and hardware.

### RELATED APPLICATIONS

The present application is a continuation application of U.S. provisional patent application, Ser. No. US60/730,150, filed Oct. 25, 2005, for METHOD OF INCREASING THE WIRELESS COMMUNICATION RANGE USING WIRELESS REPEATER/AMPLIFIER/ROUTER, by Hyun Lee, included by reference herein and for which benefit of the priority date is hereby claimed.

### FIELD OF THE INVENTION

The present invention generally relates to the fields of home and personal wireless networking, and, more particularly, to WPAN or WHAN system that is based on various standard communication protocols.

### BACKGROUND OF THE INVENTION

Recently, IEEE developed a new standard for wireless communication methods that allows interfacing with the existing data communication protocols. This newly IEEE adopted wireless communication protocol, ECMA-WiMedia, especially emphasizes on the cluster concept, which specifically limits the physical range of operation. Therefore, this protocol limits the range of communication, which results in two major disadvantages comparing to a wired protocol in user application.

The first disadvantage is the limitation on resource sharing. Since this protocol has a substantial shorter communication range (less than 10 m), each cluster would require dedicated resources within the specified physical range. This requires duplicated resources instead of being able to share resources, such as printer, among a number of clusters.

The second disadvantage is the capability of supporting mobile devices. Since the range of communication is limited, a mobile device that belongs in the cluster also has a physical range of operation.

These two disadvantages severely limit the practical usage of the ECMA-WiMedia in the targeted application, that is WPAN and WHAN.

Therefore, a new novel method is required to support WPAN and WHAN by improving the battery life of mobile equipments, and by minimizing the interferences.

Generally, the prior art employs a PC to control the entertainment/data communication among media equipment.

Another art that is currently being developed by the IEEE “High Rate” task group is the 60 GHz UWB protocol, for example, IEEE802.11n, IEEE802.16, which expends the range and doubles the data through put rate of the WiMedia protocol.

When a network is designed to be PC centric, all information/data transfers are conducted through a PC using a data communication protocol that is supported by the PC, such as the 802.11 Ethernet protocol, 1394, and USB. However, this also has the same limitation of supporting the mobile device.

A wireless network based on UWB 802.11 or 802.16 is more applicable to the longer-range wireless communication. However, due to the extreme narrow antenna beam width and the transmit power requirement, IEEE 802.11 would not applicable to the WPAN or WHAN that includes battery operated mobile equipments.

One other prior art is the cellular telephone system, which uses stationary relays to amplify and route the calls. However, this system does not address the issues that arose in the WPAN and WHAN system, such as restricting the physical operational range to reduce the interferences, and providing base wireless network to support many different media communication protocols.

It is therefore an object of the invention to increase the physical operation range of the Wireless Personal Network.

It is another object of the invention to reduce the power dissipation of any battery operated mobile equipments.

It is another object of the invention to reduce the error rate in the wireless network

It is another object of the invention to reduce interference with other existing service.

It is another object of the invention to provide a wireless routing function with protocol conversion.

It is another object of the invention to bridge to existing wired networks.

It is another object of the invention to provide the Gateway function between the entertainment networks and PC based data transfer networks.

### SUMMARY OF THE INVENTION

In accordance with the present invention, there is provided description of repeater/amplifier/router for a wireless Home Media Network to work with both existing and upcoming new wireless personal and home network protocol. This invention can be implemented in various ways, such as with firmware, with software, with hardware, or with any combinations of firmware, software, and hardware.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a table that shows the benefits check list against the state diagram in FIG. 3 (300);

FIG. 2 is a table showing the functional requirement of each stage of the state diagram in FIG. 3 (300);

FIG. 3 is a state diagram of an example that represents a rar (repeater/amplifier/router) implementation with this invention; and

FIG. 4 is a graphical representation of the method of source and destination direction/range checking procedure.

For purposes of clarity and brevity, like elements and components will bear the same designations and numbering throughout the Figures.

### DESCRIPTION OF THE PREFERRED EMBODIMENT

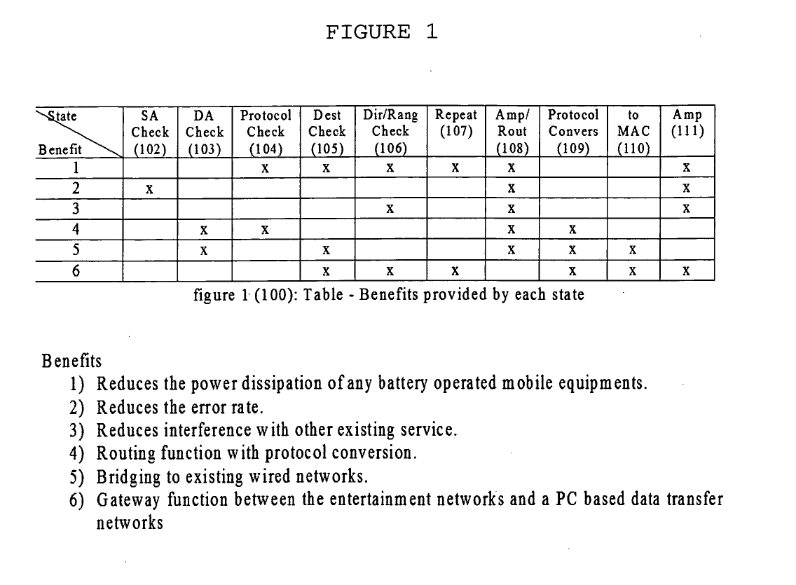

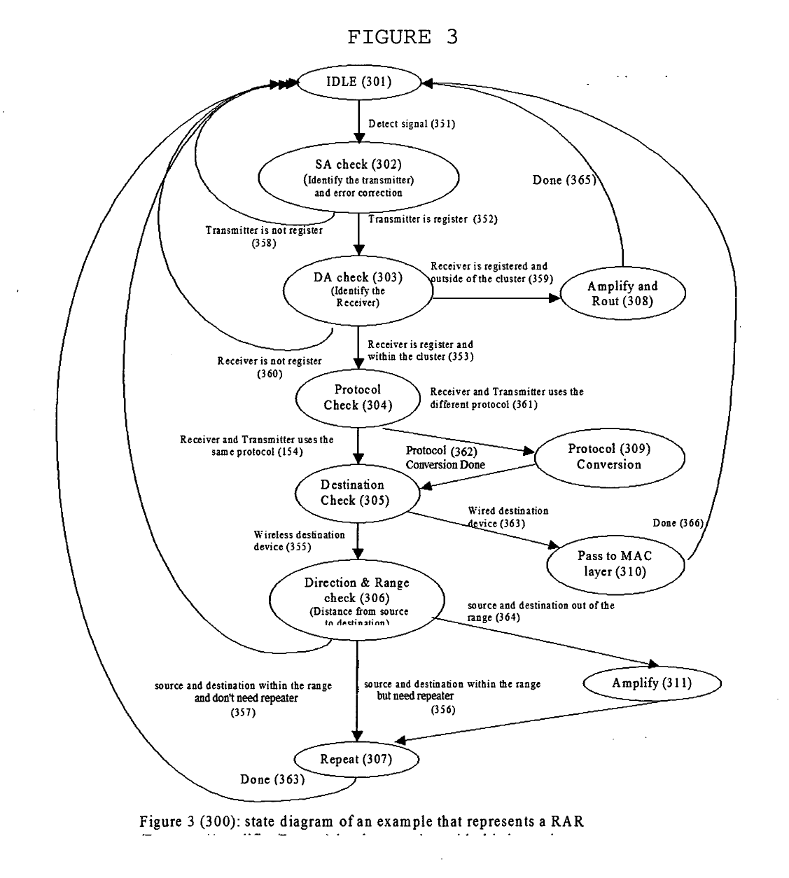

FIG. 1 is a detail view of a table shows the benefits 100 check list against the state diagram in FIG. 3 (300).

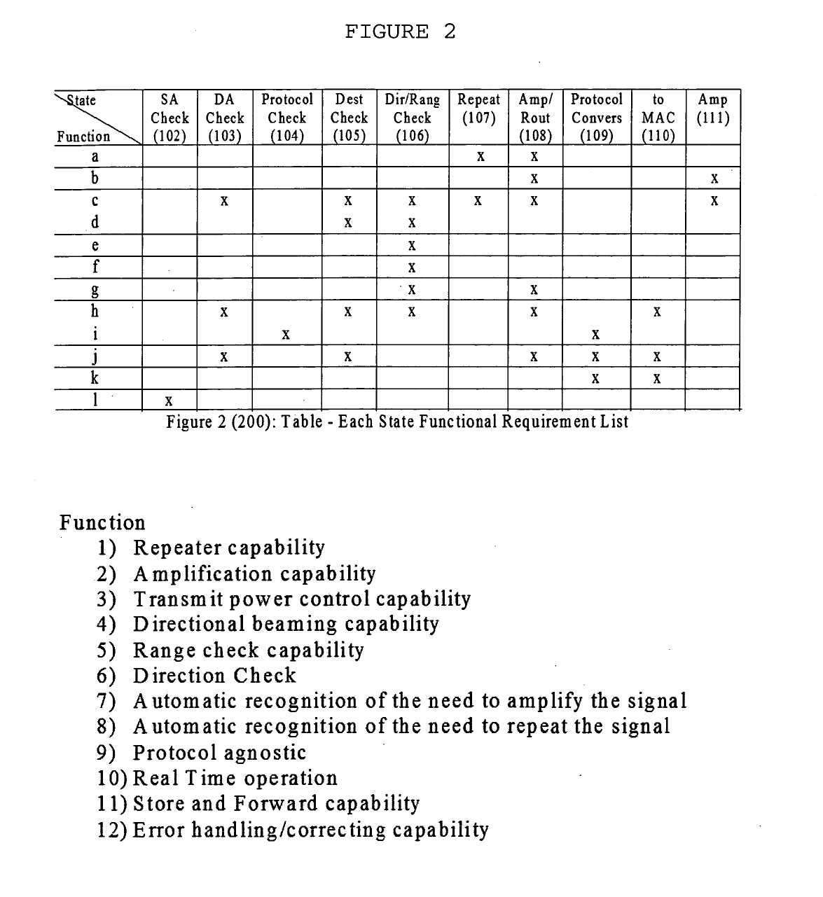

FIG. 2 is a table showing the functional requirement of each stage of the state diagram in FIG. 3 (300).

FIG. 3 is a state diagram of an example that represents a rar (repeater/amplifier 311/router) implementation with this invention.

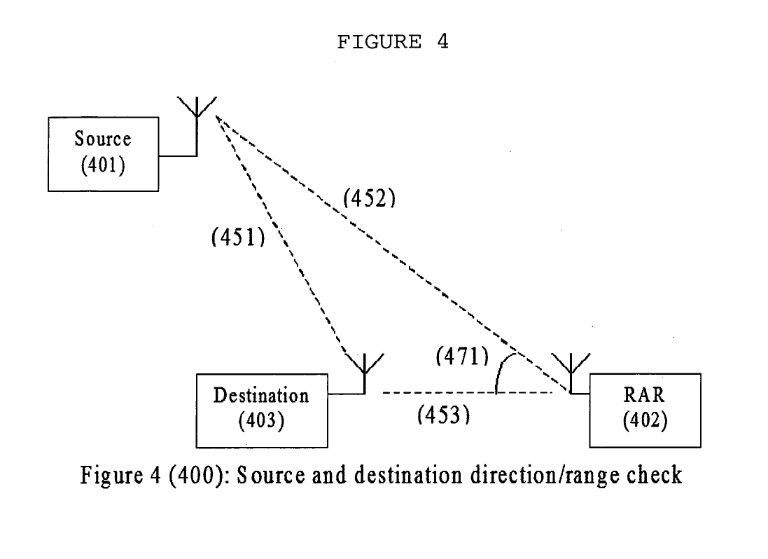

FIG. 4 is a graphical representation of the method of source 401 and destination 403 direction/range checking procedure.

The Home Media networks being discussed here generally contains any low power battery operated mobile device that needs to establish communication either with another battery operated mobile device or with a stationary device. In either case, due to the transmit power level, it may become impossible for the target device to recognize the signal even if the physical distance between these two devices are within the standard specification required range. It is troublesome for a user when communication fails between two wireless devices because the receiver fails to see the transmitted signal due to low signal strength. Furthermore, a worse case is when the receiver sees very weak signal, and tries to continuously establish communication. When the receiver sees very weak signal, not only is the power consumption by the receiver accelerated, but the error rate could also be unacceptably high to maintain any meaningful communication.

Therefore, it is necessary to place a repeater/amplifier 311/router in various places in home to reduce the battery consumption and the error rate. This repeater/amplifier 311/router needs to meet WPAN and WHAN that are very different than currently existing repeater/amplifier 311/router since it has to support multiple communication protocols in addition to other physical/electrical requirements, such as the interference reduction requirement that was made by the European Commission and the Japanese Ministry to ensure that emissions from UWB devices do not cause harmful interference to other existing services.

This invention addresses the following major benefits 100 that substantially improve the usage of the current wireless protocols (refer to FIG. 1 (100)).

1) Reduces the power dissipation of any battery operated mobile equipments.

2) Reduces the error rate.

3) Reduces interference with other existing service.

4) Routing function with protocol conversion 39.

5) Bridging to existing wired networks.

6) Gateway function between the entertainment networks and PC based data transfer networks.

The gateway function especially plays the crucial role of any media devices produced based on this invention since it allows the newly developed HDMI/HDCP protocol to communicate with any data transfer protocols, such as the 802.11 Ethernet protocol, 1394 Firewire, USB, etc.

However, there is no need to provide all these benefits 100 with a WPAN and WHAN Repeater/Amplifier 311/Router. For many cases, when a particular network needs only the Bridging function to existing wired networks, the router can simply consist of a Receiver, and a protocol conversion 39 layer, which converts the originator's protocol (such as HDMI, which is generated by the entertainment equipment) to the receiver's protocol (such as USB, which a mass storage device understands). This protocol conversion 39 function may convert the received wireless medium protocol (ex. UWB) directly to the receiver's protocol (ex. USB), or may convert the received wireless medium protocol (ex. UWB) to the originator protocol (HDMI), then covert to the receiver protocol (USB).

Any devices produced based on this invention that assume the role of a wireless repeater/amplifier 311/router need to be capable of performing at least one of the following requirements to support the WPAN and WHAN Repeater/Amplifier 311/Router function. However, one trained in this art should be capable of producing the same benefits 100 in this invention by producing different state diagrams employing a similar set of requirements. Therefore, the set of the following requirements is not the only way, but rather is one of many ways of realizing the benefit of this invention (refer to the FIG. 2 (200)),

a) Repeater capability

b) Amplification capability

c) Transmit power control capability

d) Directional beaming capability

e) Range check capability

f) Direction Check

g) Automatic recognition of the need to amplify the signal

h) Automatic recognition of the need to repeat 307 the signal

i) Protocol agnostic

j) Real Time operation

k) Store and Forward capability

l) Error handling/correcting capability

The requirement items a) and b) are the capabilities, which means that the wireless repeater/amplifier 311/router performs the repeater and/or the amplification function only if it is required to enhance the QoS (Quality of Service). The QoS is determined by the repeater/amplifier 311/router based on the information produced by the requirements c)-f) and l). The repeater/amplifier 311/router, by employing the abilities c)-h), also controls its transmit power to minimize any harmful interference to other existing services. The requirement i), j) and k) are to support various wireless equipments in the WPAN and WHAN, and to provide the gateway function. The requirement i), j), and l) are to provide the QoS requirement of the entertainment equipments that are connected with wired connectors.

The description in this application is an example of how to realize the benefits 100 of this invention by employing the requirements imposed by this invention. Since anyone trained in this field can implement the state diagram in hardware along with software (or firmware) in many different ways, the number of implementation variation of this invention is more numerous than the number of ways to develop state diagram. Therefore, the description in this application is only to demonstrate the validity of this invention

FIG. 1 (300) shows the state diagram of an example that represents a RAR (Repeater/Amplifier 311/Router) that is implemented with this invention.

The RAR moves from the IDLE 301 state (301) to the SA Check state (302) when it detects a wireless signal. The RAR intercepts this signal (351) and checks the SA (Source 401 or Transmitter Address). If the RAR recognizes the SA, then it checks the DA (303). Otherwise, the RAR does not take any action (357). After the DA check 303 (303), the RAR can take one of the 3 actions. The RAR can go back to IDLE 301 (301) state if the DA is not registered (359) with the RAR. The RAR can proceed to the protocol check 304 (304) if the DA is recognized (353). The RAR can Amplify and Route (307) the signal to a different cluster if it recognizes the DA that belongs to other cluster (358). The last condition arises when a device in one network cluster wants to communicate with a device in another network. For example, a DVD recorder is downloading a movie via Ethernet connection. When the RAR decides to enter the Amplify and Rout (308) state, it goes back to the IDLE 301 state (301) as soon as the task is completed (364).

If the RAR recognizes that the source 401 and destination 403 devices use different protocols (360), it moves into the Protocol Conversion 39 (309) state from the Protocol Check 304 (304) state, and then into the Destination Check 35 (305) state, where it checks if the destination 403 is a wired equipment (361) that is connected to the RAR. If the destination 403 is a wired device to the RAR (361), it passes the received data to the MAC layer (310) to be sent to the wired equipment. Otherwise, the RAR needs to check the Direction and Range (306) between the wireless source 401 equipment and wireless destination 403 equipment. In this state (106), the RAR computes the distance between the source 401 and destination 403 (451) from the angle (471) formed by ‘source (401)−RAR (402)−destination 403 (403)’ along with the distance from the RAR to the source 401 (452) and the distance from the RAR to destination 403 (453), possibly by using the equation;
source 401−destination 403 distance (451)=(distance (452))2+(distance (453))2−2*[(distance (452))*(distance (453))*cos (angle (471))]

Once the RAR arrives into the Distance and the Range Check (306) state, it makes one of 3 decisions. The RAR can go back to the IDLE 301 (301) state if the transmitter and the receiver share the same protocol and are within the range (356). The RAR can activate the repeater (308) if the transmitter and receiver protocols are not the same but they are within the range (355). This is the case when the RAR repeats the protocol-changed signal from the protocol conversion 39 (309). However, if the RAR detects that the receiver is outside of the range (362) (ex. greater 10m from the RAR and the source 401), it will amplify (311) the signal first and repeat 307 (or transmit) (307) using a different channel (or the same channel with a time-delay) that was used by the source 401.

The following table demonstrates that the state diagram (300) based on this invention delivers the previously listed 6 benefits 100 by utilizing the 12 functional requirements that are also listed previously. However, one trained in this art should be capable of producing the same benefits 100 in this invention by producing different state diagram employing a similar set of requirements.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of increasing the wireless communication range using wireless repeater/amplifier/router for increasing the range of operation for wireless personal and home network with minimizing the power dissipation of mobile devices, comprising:
means for checking the source address of a particular packet received;
means for checking the destination address to determine if the destination device belongs to the cluster or a neighboring cluster;
means for checking the communication protocols of the transmitter and the receiver;
means for amplifying and routing the packet. with the capability of converting the protocol if the source and the destination do not share the same protocol;
means for converting the source protocol to the destination protocol if the source and destination protocols are not the same;
means for checking the physical location of the destination device;
means for passing the packet from a wireless channel to the wired mac layer;
means for initiating the distance check procedure;
means for amplifying the signal if the physical linear distance between the source and the destination is too far to establish a direct communication channel;
means for repeating the signal in a different channel with automatically converted protocol for the destination;
means for completing the packet transfer; and
means for computing the linear distance between the source and destination using the cosine angle rule.

2. The method of increasing the wireless communication range using wireless repeater/amplifier/router in accordance with claim 1, wherein said means for checking the source address of a particular packet received comprises a capability to recognize whether the source belongs to the network cluster or not by identifying source address.

3. The method of increasing the wireless communication range using wireless repeater/amplifier/router in accordance with claim 1, wherein said means for checking the destination address to determine if the destination device belongs to the cluster or a neighboring cluster comprises a da check.

4. The method of increasing the wireless communication range using wireless repeater/amplifier/router in accordance with claim 1, wherein said means for checking the communication protocols of the transmitter and the receiver comprises a capability to recognize the communication channels of the source and the destination devices, distance computer that computes linear distance between any two devices based on the range check results initiated by protocol check.

5. The method of increasing the wireless communication range using wireless repeater/amplifier/router in accordance with claim 1, wherein said means for amplifying and routing the packet. with the capability of converting the protocol if the source and the destination do not share the same protocol comprises a capabilites to amamplify and rout.

6. The method of increasing the wireless communication range using wireless repeater/amplifier/router in accordance with claim 1, wherein said means for converting the source protocol to the destination protocol if the source and destination protocols are not the same comprises a capability of protocol conversion.

7. The method of increasing the wireless communication range using wireless repeater/amplifier/router in accordance with claim 1, wherein said means for checking the physical location of the destination device comprises an address map of all the devices in the network for destination check.

8. The method of increasing the wireless communication range using wireless repeater/amplifier/router in accordance with claim 1, wherein said means for passing the packet from a wireless channel to the wired mac layer comprises a signal converter that converts from wireless signals to wired signals pass to mac layer.

9. The method of increasing the wireless communication range using wireless repeater/amplifier/router in accordance with claim 1, wherein said means for initiating the distance check procedure comprises a capability of deciding whether the physical location of the destination is within the communication range of the source by checking the distance & range of the target.

10. The method of increasing the wireless communication range using wireless repeater/amplifier/router in accordance with claim 1, wherein said means for amplifying the signal if the physical linear distance between the source and the destination is too far to establish a direct communication channel comprises an amplifier.

11. The method of increasing the wireless communication range using wireless repeater/amplifier/router in accordance with claim 1, wherein said means for repeating the signal in a different channel with automatically converted protocol for the destination comprises a capability of change the communication channel prior to repeat.

12. The method of increasing the wireless communication range using wireless repeater/amplifier/router in accordance with claim 1, wherein said means for completing the packet transfer comprises an action completion done.

13. The method of increasing the wireless communication range using wireless repeater/amplifier/router in accordance with claim 1, wherein said means for computing the linear distance between the source and destination using the cosine angle rule comprises a distance computer that computes linear distance between any two devices based on the range check results initiated by repeater router amplifier.

14. A method of increasing the wireless communication range using wireless repeater/amplifier/router for increasing the range of operation for wireless personal and home network with minimizing the power dissipation of mobile devices, comprising:
a capability to recognize whether the source belongs to the network cluster or not by identifying source address, for checking the source address of a particular packet received;
a da check, for checking the destination address to determine if the destination device belongs to the cluster or a neighboring cluster;
a capability to recognize the communication channels of the source and the destination devices, distance computer that computes linear distance between any two devices based on the range check results initiated by protocol check, for checking the communication protocols of the transmitter and the receiver;
a capabilites to amamplify and rout, for amplifying and routing the packet. with the capability of converting the protocol if the source and the destination do not share the same protocol;
a capability of protocol conversion, for converting the source protocol to the destination protocol if the source and destination protocols are not the same;
an address map of all the devices in the network for destination check, for checking the physical location of the destination device;
a signal converter that converts from wireless signals to wired signals pass to mac layer, for passing the packet from a wireless channel to the wired mac layer;
a capability of deciding whether the physical location of the destination is within the communication range of the source by checking the distance & range of the target, for initiating the distance check procedure;
an amplifier, for amplifying the signal if the physical linear distance between the source and the destination is too far to establish a direct communication channel;
a capability of change the communication channel prior to repeat, for repeating the signal in a different channel with automatically converted protocol for the destination;
an action completion done, for completing the packet transfer; and
a distance computer that computes linear distance between any two devices based on the range check results initiated by repeater router amplifier, for computing the linear distance between the source and destination using the cosine angle rule.

15. The method of increasing the wireless communication range using wireless repeater/amplifier/router as recited in claim 14, further comprising:
a benefit of reducing the power dissipation of any battery operated equipments, benefit of reducing error rate, benefit of reducing interference with the existing services, benefit of providing routing function with protocol conversion, benefit of providing gateway between the entertainment network, mobile network, and pc based data transfer network, benefit of bridging to existing wired networks benefits, for identifying the list of other benefits (in addition to increasing the communication range).

16. The method of increasing the wireless communication range using wireless repeater/amplifier/router as recited in claim 14, further comprising:
a repeater, amplifier, transmit power controller, directional beaming, range checker, direction checker, automatic recognition of the need to amplify the signal, automatic recognition of the need to repeat the signal, protocol agnostic, real time operation, store-and-forward, error handling/correcting capabilities that may be needed for each state in the state diagram in FIG. 3, for supporting functions for improving the wireless communication range and other benefits in FIG. 1.

17. The method of increasing the wireless communication range using wireless repeater/amplifier/router as recited in claim 14, further comprising:
a source—destination distance, for indicating the linear distance between the source and the destination.

18. The method of increasing the wireless communication range using wireless repeater/amplifier/router as recited in claim 15, further comprising:
a repeater, amplifier, transmit power controller, directional beaming, range checker, direction checker, automatic recognition of the need to amplify the signal, automatic recognition of the need to repeat the signal, protocol agnostic, real time operation, store-and-forward, error handling/correcting capabilities that may be needed for each state in the state diagram in FIG. 3, for supporting functions for improving the wireless communication range and other benefits in FIG. 1.
